(19) United States
(12) Patent Application Publication
(10) Pub. No.: US 2018/0207656 A1
(43) Pub. Date: Jul. 26, 2018

(54) SPRAYING OR FUMING SCOOTER

(71) Applicant: Tienhao Wang, Dongguan (CN)

(72) Inventor: Tienhao Wang, Dongguan (CN)

(21) Appl. No.: 15/496,010

(22) Filed: Apr. 25, 2017

Related U.S. Application Data
(63) Continuation of application No. PCT/CN2017/078073, filed on Mar. 24, 2017.

(30) Foreign Application Priority Data
Jan. 20, 2017 (CN) 201720072519X
Jan. 20, 2017 (CN) 2017200718726

(51) Int. Cl. B05B 9/00; A63C 17/01; A63C 17/26; A63C 17/00; B05B 12/00

(52) U.S. Cl. CPC B05B 9/007; A63C 17/011; A63C 2203/14; A63C 17/0006; B05B 12/002; A63C 17/26

(57) ABSTRACT

The disclosure discloses a spraying or fuming scooter, including a pedal base, front wheels, a rear wheel, a handle rod, a water tank, a spraying device disposed on an outlet of the water tank, and a circuit control component. The disclosure disposes an electric wire in the handle rod to enhance reliability and stability of circuit control. A light-emitting printed circuit board and a spraying piece are fixated on a nozzle of the water tank manufactured by blow molding via a fixing trestle cylinder. Water is added from an inlet of the water tank. After energization, mists atomized by the spraying piece are illuminated by a LED light-emitting light group of the light-emitting printed circuit board to show the mists with various colors. The mists simulate emission from engines of airplanes, vehicles and motorcycles, which can enhance entertainment and excitement of the scooter in the disclosure.

### TECHNICAL FIELD

The disclosure relates to a scooter technical field, and more particularly to a spraying or fuming scooter.

### DESCRIPTION OF RELATED ART

A bewildering variety of scooters are on offer to satisfy requirements of different customers, such as ones with additional functions for enhancing interest and entertainment of the scooters. A spraying scooter is one of them.

The prior art, such as a Chinese patent entitled spraying scooter whose number is CN204489034U, includes a pedal seat, front wheels, a rear wheel, a straight pipe provided with a handle and spraying devices arranged on the tail portion of the pedal seat. The spraying device includes a water tank, a spraying circuit, an atomization piece, a control switch and a battery. The scooter further includes red light LED lamps and green light LED lamps. The light of the red light LED lamps and the green light LED lamps can be emitted toward the atomized gas generated by the spraying devices, and the green light generated by the green light LED lamps is in front of the red light generated by the red light LED lamps. According to the spraying scooter, the rocket launching effect is more vivid, and the entertainment is greater. But two main shortcomings exist in practical utilization. First, the water tank is produced by injection molding, six or seven components are required, which are difficult for assembling and pricy; second, the only function is spraying, the function of playing music is lacked. Or such as another Chinese patent entitled atomizing scooter whose number is CN203318588U, the main shortage is that connecting wires in the circuit control component are exposed to the air, which can easily be damaged due to external factors and break off the circuit control, further threatening safety of children.

Therefore, in the disclosure, the applicant will further improve the structure and the design thereof.

### SUMMARY

In order to overcome shortcomings of the prior art, the disclosure provides a spraying or fuming scooter, whose structure is more reasonable. The spraying effect and entertainment are better.

In order to achieve the objective above, the disclosure provides a spraying or fuming scooter, including a pedal base, front wheels, a rear wheel, a handle rod equipped with a handle, a water tank, a spraying device disposed on an outlet of the water tank, and a circuit control component. The circuit control component includes a battery, a power switch, a spraying piece control switch and a central controller. The battery, the power switch, the spraying piece control switch are electrically connected with the central controller respectively. The pedal base includes a polymeric top cover and a bottom cover. The spraying device includes a spraying piece. The spraying piece and the central controller are electrically connected. The water tank is disposed with an inlet and a nozzle. A water tank lid covers the inlet. The nozzle is disposed with a fixing trestle cylinder configured to fix the spraying piece and a light-emitting printed circuit board. An outside of the fixing trestle cylinder is disposed with a light board fixing trestle. The light-emitting printed circuit board is disposed with a LED light group. The LED light group and the central controller are electrically connected. The water tank is manufactured by integral moulding.

In an embodiment of the disclosure, the handle rod includes the handle, an internal rod, an external rod, an upper link rod, a top rod, a spring, an electric wire and a lower link rod connected in sequence. The external rod surrounds an external surface of the internal rod. A bottom of the lower link rod is securely linked with the pedal base. Rotation and fold between the upper link rod and the lower link rod are achieved by a rotary axis. A bottom-up blind groove built-in the top rod is disposed in the upper link rod. The spring is disposed between the top rod and a bottom of the blind groove. The lower link rod is disposed with a mounting hole for an end of the top rod to be inserted. The power switch and the spraying piece control switch are disposed on the handle. The electric wire is disposed in the internal rod and passing through a via hole that penetrates the upper link rod from a top end to a bottom end, entering the lower link rod and the pedal base. The power switch and the central controller are electrically connected by the electric wire. The spraying piece control switch and the central controller are electrically connected by the electric wire.

In an embodiment of the disclosure, a brake cable is disposed in the handle along the electric wire.

In an embodiment of the disclosure, a central axis of the blind groove is eccentric to a central axis of the upper link rod.

In an embodiment of the disclosure, the water tank is manufactured by blow molding.

In an embodiment of the disclosure, the fixing trestle cylinder is cylindrical. The spraying piece is disposed in the fixing trestle cylinder and screwed on an outside of the nozzle by a buckle or a thread. The light-emitting printed circuit board is fixed between the fixing trestle cylinder and the light board fixing trestle. The light-emitting circuit board is defined with a via hole to communicate the spraying piece and the light board fixing trestle.

In an embodiment of the disclosure, the light board fixing trestle is defined with a light-emitting hole through the LED light group.

In an embodiment of the disclosure, a thread is disposed between the nozzle and the fixing trestle cylinder for secure connection.

In an embodiment of the disclosure, the polymeric top cover is defined with a watering hole corresponding to the inlet. The water tank lid is disposed in the watering hole.

To further illustrate the disclosure, the circuit control component further includes a TF card slot and a playing circuit, electrically connected with the central controller respectively.

Compared with the prior art, beneficial effects of the disclosure are: first, fixing the light-emitting printed circuit board and the spraying piece on the nozzle of the water tank manufactured by blow molding via the fixing trestle cylinder, adding water from the inlet of the water tank; after energization, mists atomized by the spraying piece are illuminated by the LED light-emitting light group of the light-emitting printed circuit board to show the mists with various colors, which can enhance entertainment of the scooter. Second, the spraying piece is securely fixed on the nozzle by the fixing trestle cylinder, which is convenient for assembly and improves the production efficiency. Third, the water tank manufactured by blow molding further reduces costs, which also improves competition of the enterprise. Fourth, the electric wire disposed in the handle rod can protect the electric wire and prolong the service life of circuit control, and enhance safety of children. Fifth, customers can download music to a TF card due to the addition of the TF card slot. The TF card is inserted in the TF card slot and the playing circuit works, which can significantly increase entertainment, interest and excitement.

### BRIEF DESCRIPTION OF THE DRAWINGS

FIG. 1 is a first schematic view of an integrated structure according to the disclosure.

FIG. 2 is a second schematic view of an integrated structure according to the disclosure.

FIG. 3 is a third schematic view of an integrated structure according to the disclosure.

FIG. 4 is a structural schematic view of a cross-section according to the disclosure.

FIG. 5 is an enlarged structural schematic view of a section A in FIG. 4.

FIG. 6 is a structural schematic view of disintegration of the disclosure.

FIGS. 7-8 are circuit principle diagrams of a circuit control component according to an embodiment of the disclosure.

Illustration of labels in the figures: 1, pedal base; 2, front wheel; 3, rear wheel; 4, handle rod; 5, water tank; 6, fixing trestle cylinder; 7, silica gel water-proof pad; 8, light board fixing trestle; 9, spraying piece; 10, light-emitting printed circuit board; 11, LED light group; 101, polymeric top cover; 102, bottom cover; 401, handle; 402, internal rod; 403, external rod; 404, sliding device; 405, upper link rod; 406, top rod; 407, spring; 408, electric wire; 409, lower link rod; 410, buckle; 411, blind groove; 412, mounting hole; 413, linkage component; 415, via hole; 416, rotary axis; 501, inlet; 502, nozzle; 503, water tank lid.

### DETAILED DESCRIPTION OF PREFERRED EMBODIMENTS

A specific embodiment of the disclosure will be introduced with reference to accompanying drawings as follows.

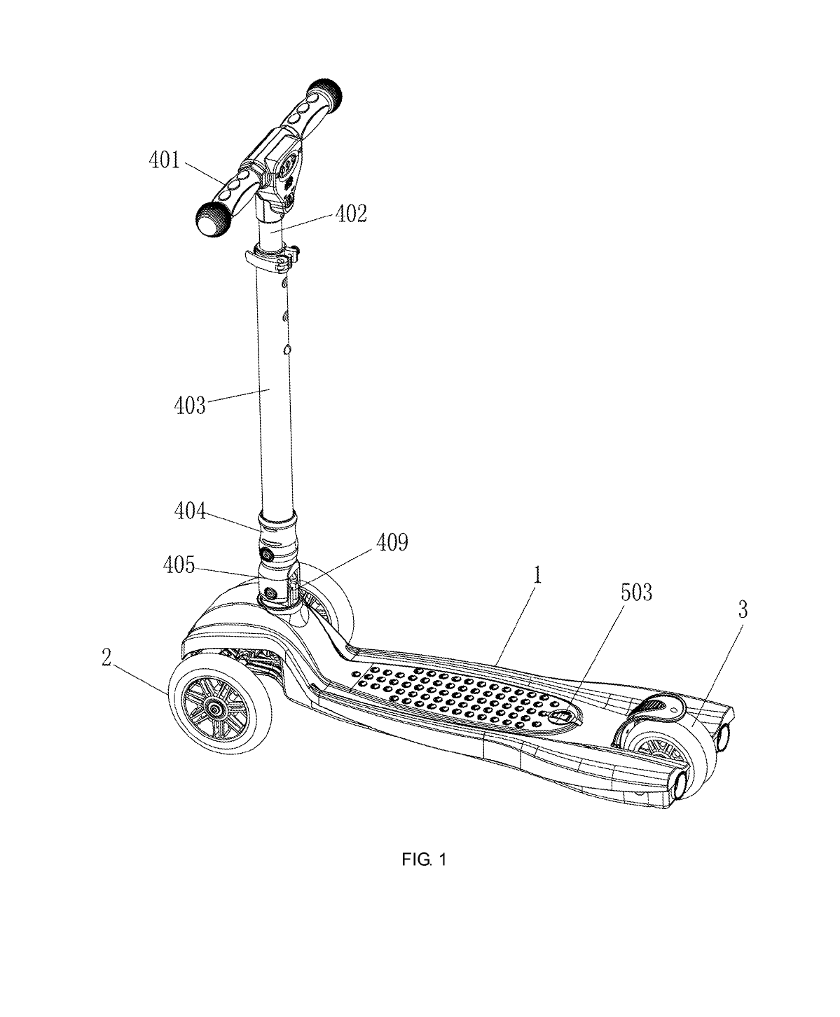

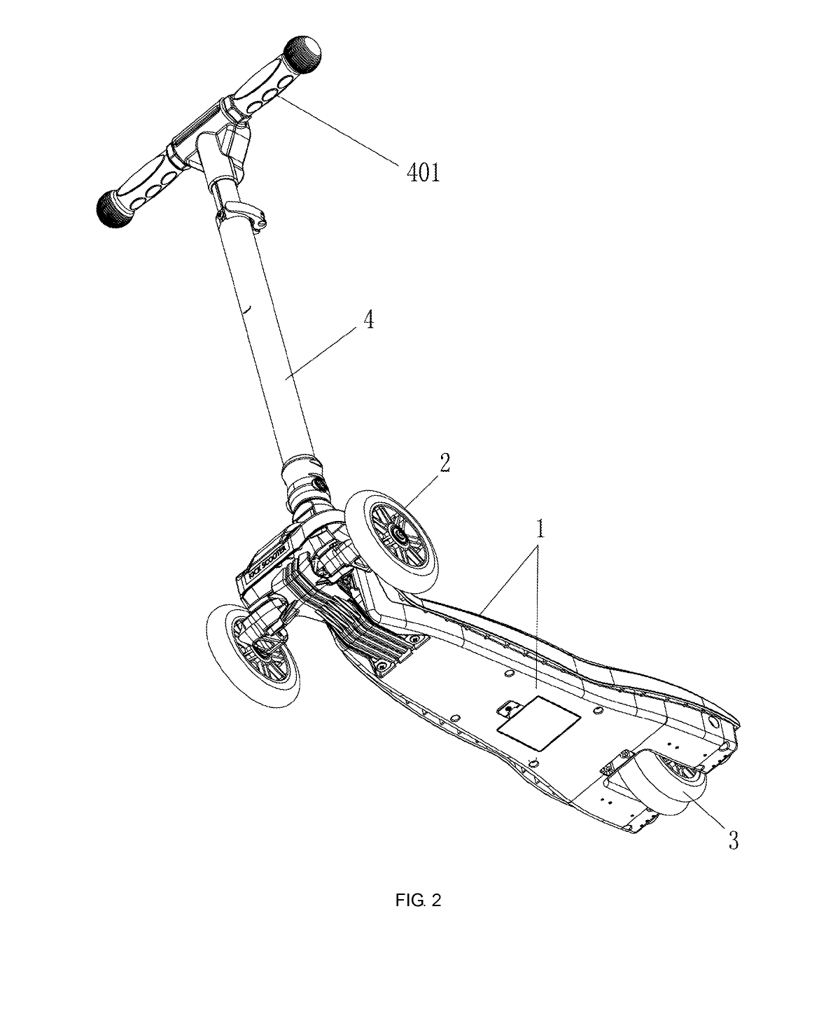

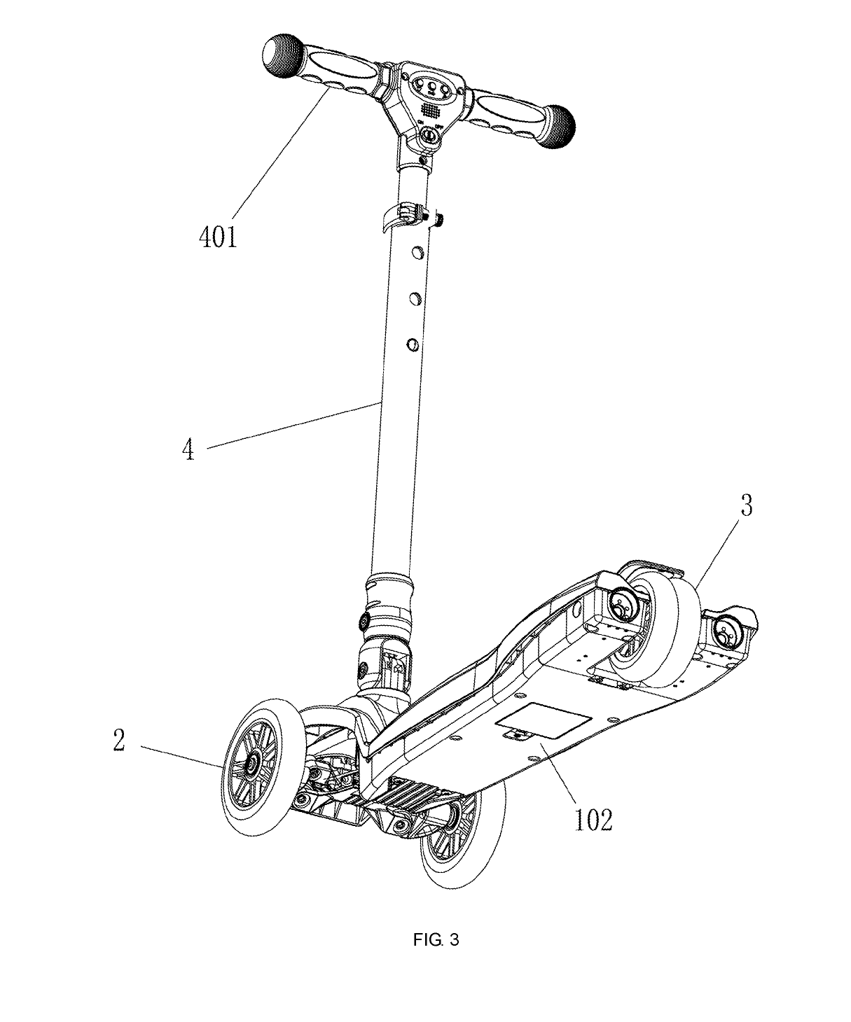

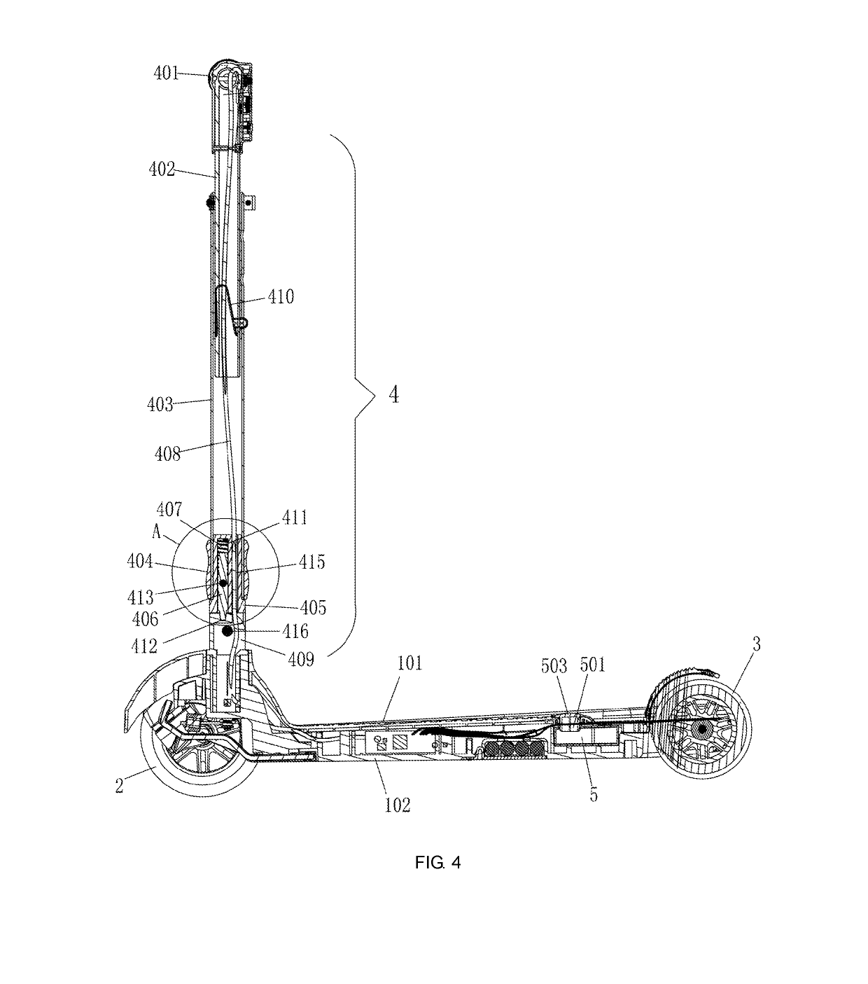

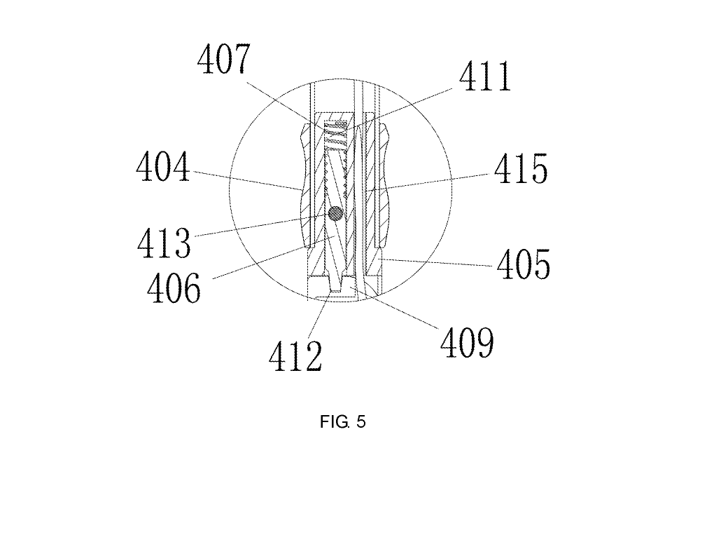

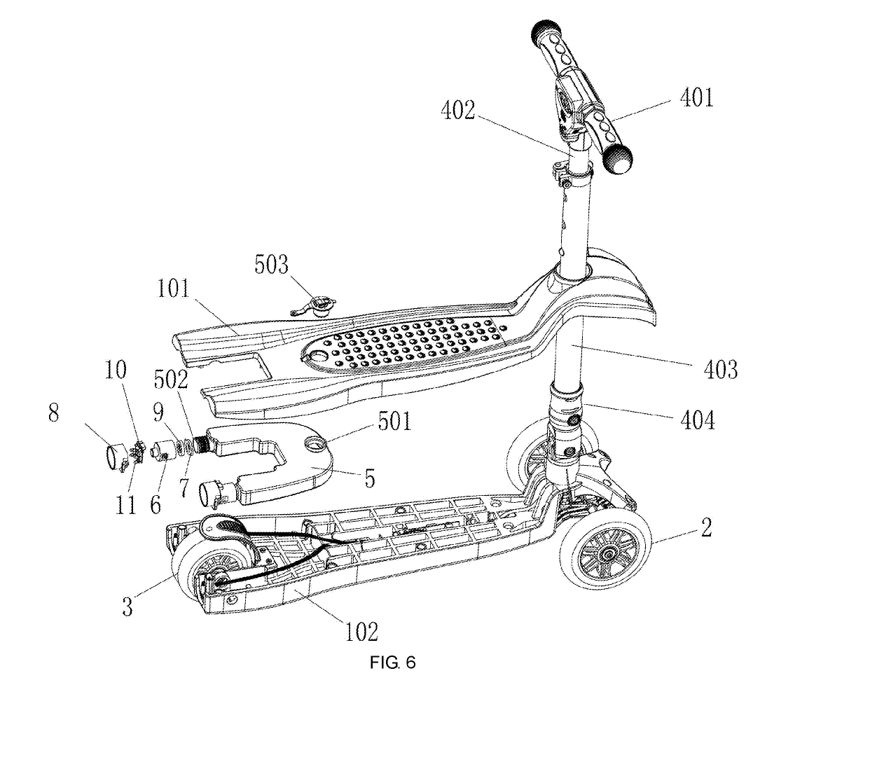

As shown in FIGS. 1-6, a spraying or fuming scooter includes a pedal base 1, front wheels 2, a rear wheel 3, a handle rod 4 equipped with a handle 401, a water tank 5, a spraying device disposed on an outlet of the water tank 5, and a circuit control component. The circuit control component includes a battery, a power switch, a spraying piece control switch and a central controller. The battery, the power switch, the spraying piece control switch are electrically connected with the central controller respectively. The pedal base 1 includes a polymeric top cover 101 and a bottom cover 102. The spraying device includes a spraying piece 9. The spraying piece 9 and the central controller are electrically connected. The water tank 5 is disposed between the polymeric top cover 101 and the bottom cover 102. The water tank 5 is disposed with an inlet 501 and a nozzle 502. A water tank lid 503 covers the inlet 501. The nozzle 502 is disposed with a fixing trestle cylinder 6 configured to fixate the spraying piece 9 and a light-emitting printed circuit board 10. The outside of the fixing trestle cylinder 6 is disposed with a light board fixing trestle 8. The light-emitting printed circuit board 10 is disposed with a LED light group 11. The LED light group 11 and the central controller are electrically connected. The water tank 5 is manufactured by integral moulding, such as blow molding.

The fixing trestle cylinder 6 is cylindrical. The spraying piece 9 is disposed in the fixing trestle cylinder 6 and screwed on the outside of the nozzle 502 by a buckle or a thread. A silica gel water-proof pad 7 is disposed between the spraying piece 9 and the nozzle 502. The silica gel water-proof pad 7 and the fixing trestle cylinder 6 are stuck or connected by the thread. The spraying piece 9 is fixed in the fixing trestle cylinder 6. A round hole is defined in the middle of the silica gel water-proof pad 7 for pouring water in the spraying piece 9. The light-emitting printed circuit board 10 is fixed between the fixing trestle cylinder 6 and the light board fixing trestle 8. The light-emitting circuit board 10 is defined with a via hole to communicate the spraying piece 9 and the light board fixing trestle 8. The light board fixing trestle 8 is defined with a light-emitting hole through the LED light group 11. The thread is disposed between the external surface of the nozzle 502 and the internal surface of the fixing trestle cylinder 6 for secure connection. The polymeric top cover 101 is defined with a watering hole corresponding to the inlet 501. The water tank lid 503 is disposed in the watering hole and covers the inlet 501. The fixing trestle cylinder 6 and the bottom cover 102 are stuck for fixation. The light board fixing trestle 8 and the bottom cover 102 are fixated by the thread.

The light-emitting printed circuit board 10 and the spraying piece 9 are fixated on the nozzle 502 of the water tank 5 manufactured by for example blow molding via the fixing trestle cylinder 6. Water is added from the inlet 501 of the water tank 5. After energization, mists atomized by the spraying piece 9 are illuminated by the LED light-emitting light group 11 of the light-emitting printed circuit board 10 to show the mists with various colors, which can enhance entertainment of the scooter.

The handle rod 4 includes the handle 401, an internal rod 402, an external rod 403, an upper link rod 405, a top rod 406, a spring 407, an electric wire 408 and a lower link rod 409 connected in sequence. The external rod 403 surrounds the external surface of the internal rod 402. The bottom of the lower link rod 409 is securely linked with the pedal base 1. Rotation and fold between the upper link rod 405 and the lower link rod 409 are achieved by a rotary axis 416. A bottom-up blind groove 411 built-in the top rod 406 is disposed in the upper link rod 405. The spring 407 is disposed between the top rod 406 and the bottom of the blind groove 411. The lower link rod 409 is disposed with a mounting hole 412 for an end of the top rod 406 to be inserted. A sliding device 404 can surround the outer surface of the external rod 403 in a movable manner, and synchronously connected with the top rod 406 by the linkage component 413. The external rod 403 and the upper link rod 405 are both disposed with slits for penetration and axial movement of the linkage component 413. The power switch and the spraying piece control switch are disposed on the handle 401. The electric wire 408 is disposed in the internal rod 402 and passing through a via hole 415 that penetrates the upper link rod 405 from the top end to the bottom end, entering the lower link rod 409 and the pedal base 1. The power switch and the central controller are electrically connected by the electric wire 408. The spraying piece control switch and the central controller are electrically connected by the electric wire 408.

A brake cable is disposed in the handle along the electric wire. The brake cable and the electric wire both penetrate the via hole.

A central axis of the blind groove 411 is eccentric to a central axis of the upper link rod 405. As the blind groove is not located at the center of the upper link rod, the internal diameter of the via hole can be larger, so that the space to accommodate the brake cable or the electric wire can be more abundant, and the electric wire or the brake cable will not be restricted due to the limited space, which can guarantee the usage.

The circuit control component further includes a TF card slot and a playing circuit, electrically connected with the central controller respectively. The playing circuit includes a playing IC, a power amplifier IC and a speaker.

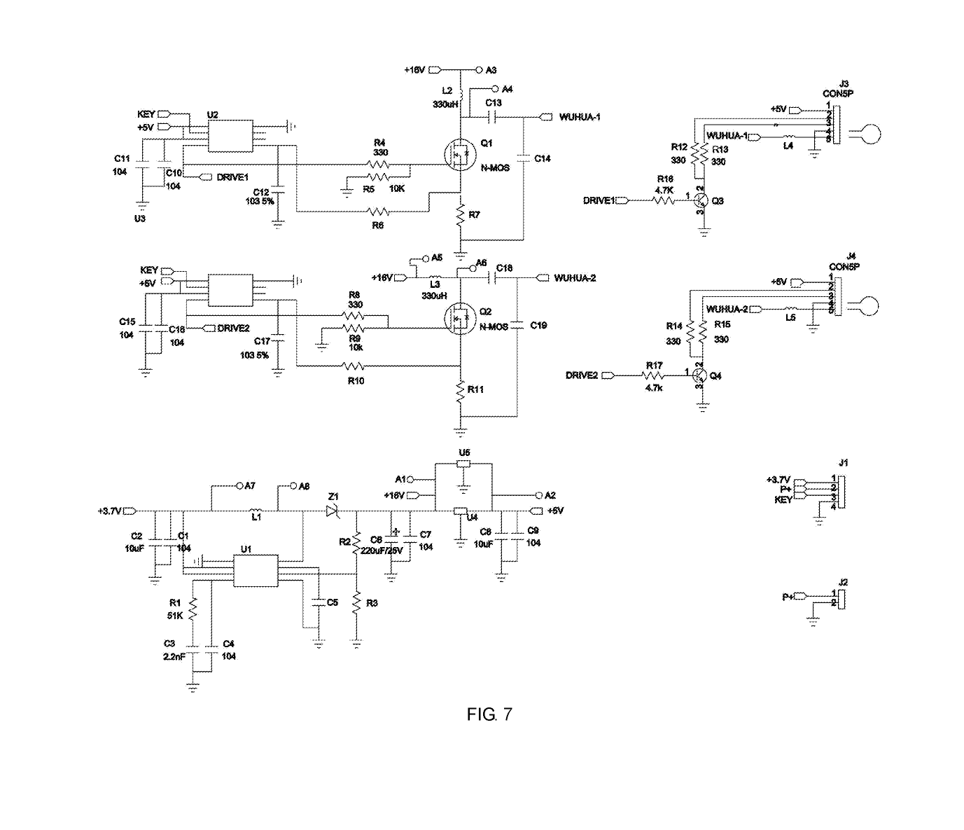

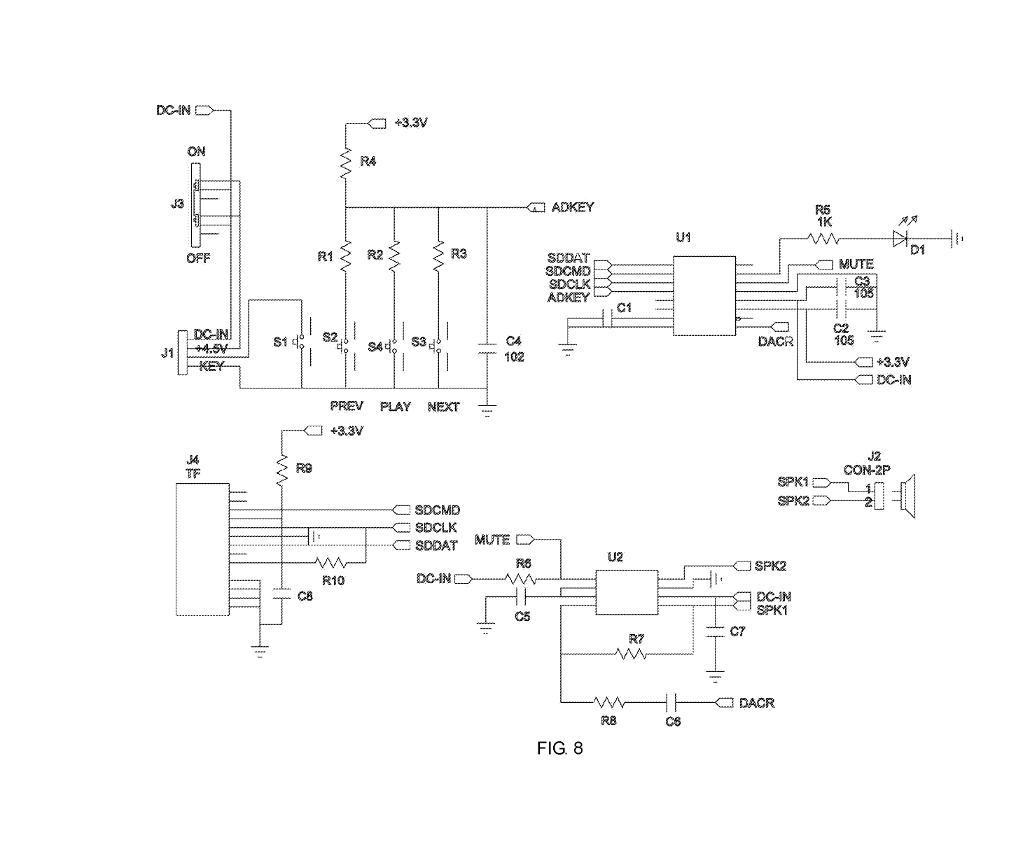

FIGS. 7-8 show the specific embodiment of the circuit control component.

U1 on the mainboard is a boost IC of DC-DC, and the model is SDB842X, the function of which is to increase the voltage of the lithium ion battery from 3.7V to 16-18V and provide the voltage to the spraying piece driving circuit. The driving waveform achieves the high voltage required for operating the spraying piece and drives the spraying piece to work.

U2 and U3 on the mainboard are ICs specialized for atomization. The model is XY1087SK30. The function thereof is to generate the waveform required by the spraying piece and drive the circuit by the MOS transistor and the spraying piece consisting of inductance to generate the waveform of high voltage to be loaded on two ends of the spraying piece, and the spraying piece can work properly. The water in the water tank is converted into mists for spraying. The ICs specialized for atomization have the function of scanning the operational frequency of the spraying piece automatically and outputting the frequency in accordance with the spraying piece, and the spraying piece can work with the optimum frequency. The ICs specialized for atomization are controlled by a spray button (S1) on the keyboard. The spraying IC initiates to output the waveform by pressing the spray button (S1), and the spraying piece starts to spray. The process of spraying will be stopped automatically after 30 seconds. In the process of spraying, the spray button can be re-pressed to stop the process.

U1 on the music keyboard is a TF card music playing IC, and the model is KT2083, which can identify music files in the TF card automatically for auto-playing. Three manipulation keys can control the functions such as play/pause(S4), previous/volume−(S2) and next/volume+(S3), and the manipulation (long press for volume− and volume+, one press for previous and next) is simple.

U2 on the music keyboard is the power amplifier IC (8002B). Music files amplify audio signals to drive the waveform of the speaker by the power amplifier IC for driving the speaker to work.

The embodiments described above do not represent any limitation on the technical scope of the disclosure. Any modification or equivalent alteration of the embodiments above according to the spirit of the disclosure belongs to the scope of the disclosure.

What is claimed is:

1. A spraying or fuming scooter, comprising a pedal base, front wheels, a rear wheel, a handle rod equipped with a handle, a water tank, a spraying device disposed on an outlet of the water tank, and a circuit control component; the circuit control component comprising a battery, a power switch, a spraying piece control switch and a central controller, the battery, the power switch, the spraying piece control switch electrically connected with the central controller respectively; the pedal base comprising a polymeric top cover and a bottom cover; the spraying device comprising a spraying piece, the spraying piece and the central controller electrically connected; the water tank disposed with an inlet and a nozzle, a water tank lid covering the inlet; the nozzle disposed with a fixing trestle cylinder configured to fix the spraying piece and a light-emitting printed circuit board; an outside of the fixing trestle cylinder disposed with a light board fixing trestle; the light-emitting printed circuit board disposed with a LED light group, the LED light group and the central controller electrically connected; the water tank manufactured by integral moulding.

2. The spraying or fuming scooter according to claim 1, wherein the handle rod comprises the handle, an internal rod, an external rod, an upper link rod, a top rod, a spring, an electric wire and a lower link rod connected in sequence; the external rod surrounds an external surface of the internal rod, a bottom of the lower link rod is securely linked with the pedal base, rotation and fold between the upper link rod and the lower link rod are achieved by a rotary axis; a bottom-up blind groove built-in the top rod is disposed in the upper link rod, the spring is disposed between the top rod and a bottom of the blind groove, the lower link rod is disposed with a mounting hole for insertion of an end of the top rod; the power switch and the spraying piece control switch are disposed on the handle, the electric wire is disposed in the internal rod and passing through a via hole that penetrates the upper link rod from a top end to a bottom end, entering the lower link rod and the pedal base, the power switch and the central controller are electrically connected by the electric wire, the spraying piece control switch and the central controller are electrically connected by the electric wire.

3. The spraying or fuming scooter according to claim 2, wherein a brake cable is disposed in the handle along the electric wire.

4. The spraying or fuming scooter according to claim 2, wherein a central axis of the blind groove is eccentric to a central axis of the upper link rod.

5. The spraying or fuming scooter according to claim 1, wherein the water tank is manufactured by blow molding.

6. The spraying or fuming scooter according to claim 1, wherein the fixing trestle cylinder is cylindrical; the spraying piece is disposed in the fixing trestle cylinder and screwed on an outside of the nozzle by a buckle or a thread, the light-emitting printed circuit board is fixed between the fixing trestle cylinder and the light board fixing trestle; the light-emitting circuit board is defined with a via hole to communicate the spraying piece and the light board fixing trestle.

7. The spraying or fuming scooter according to claim 1, wherein the light board fixing trestle is defined with a light-emitting hole through the LED light group.

8. The spraying or fuming scooter according to claim 1, wherein a thread is disposed between the nozzle and the fixing trestle cylinder for secure connection.

9. The spraying or fuming scooter according to claim 1, wherein the polymeric top cover is defined with a watering hole corresponding to the inlet, the water tank lid is disposed in the watering hole.

10. The spraying or fuming scooter according to claim 1, wherein the circuit control component further comprises a TF card slot and a playing circuit, electrically connected with the central controller respectively.
